(19) United States
(12) Patent Application Publication
(10) Pub. No.: US 2017/0176665 A1
(43) Pub. Date: Jun. 22, 2017

(54) EDGE-LIT LUMINARIE

(71) Applicant: 3M INNOVATIVE PROPERTIES COMPANY, St. Paul, MN (US)

(72) Inventor: Byoung-kyu Kim, Busan-City (KR)

(21) Appl. No.: 15/381,469

(22) Filed: Dec. 16, 2016

Related U.S. Application Data
(60) Provisional application No. 62/268,334, filed on Dec. 16, 2015.

(51) Int. Cl. F21V 8/00

(52) U.S. Cl. CPC G02B 6/0045; G02B 6/0053; G02B 6/0055

(57) ABSTRACT

Edge-lit luminaires are described. In particular, edge-lit luminaires with a light source; a structured lightguide having an input edge, a first major surface including a plurality of prisms, and a second major surface including a plurality of lenslets; and a structured film having a first major surface including a plurality of prisms and a second major surface including a plurality of lenslets are described. The luminaire is configured such that the second major surface of the structured lightguide and the second major surface of the structured film are nearer one another than the first major surface of the structured lightguide and the first major surface of the structured film.

### BACKGROUND

Luminaires provide general, decorative, or task-specific lighting to an area or room. Edge-lit luminaires use a lightguide to transport light from light sources located along the edge of the luminaire to an emission area of the luminaire. Light extraction features cause the light to be extracted at particular locations along the lightguide.

### SUMMARY

In one aspect, the present description relates to an edge-lit luminaire. The edge-lit luminaire includes a light source, a structured lightguide, and a structured film. The structured lightguide has an input edge, a first major surface including a plurality of prisms, and a second major surface including a plurality of lenslets. The structured film has a first major surface including a plurality of prisms and a second major surface including a plurality of lenslets. The luminaire is configured such that the second major surface of the structured lightguide and the second major surface of the structured film are nearer one another than the first major surface of the structured lightguide and the first major surface of the structured film.

### BRIEF DESCRIPTION OF THE DRAWINGS

FIG. 1 is a side elevation view of an edge-lit luminaire.

FIG. 2 is a side elevation view of the structured lightguide of the edge-lit luminaire of FIG. 1.

FIG. 3 is a plot of the cross-section of the horizontal light distribution of Example 1.

FIG. 4 is a plot of the cross-section of the horizontal light distribution of Example 2

FIG. 5 is a plot of the cross-section of the horizontal light distribution of Example 3.

FIG. 6 is a plot of the cross-section of the horizontal light distribution of Example 4.

FIG. 7 is a plot of the cross-section of the horizontal light distribution of Comparative Example 1.

FIG. 8 is a plot of the cross-section of the horizontal light distribution of Comparative Example 2.

### DETAILED DESCRIPTION

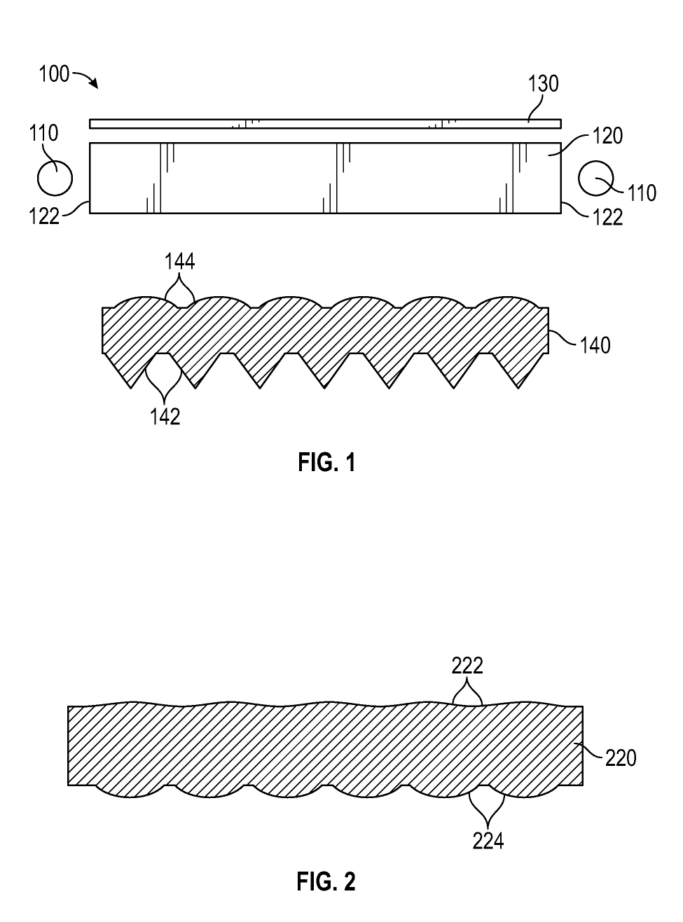

Conventional overhead luminaires utilize an area light source such as an array of LEDs. A strong diffuser to attempt to hide the light/dark pattern formed by the light sources being discretely positioned within the luminaire. The output for such a conventional luminaire typically is directly below the conventional luminaire. FIG. 1 is a side elevation view of an edge-lit luminaire. As overhead luminaires are often relied upon to illuminate all areas of a room, more luminaires may be needed to provide the necessary illuminance than may otherwise be expected based on the luminous flux of the luminaires.

Light distributions which provide more oblique angle light can help in allowing overhead luminaire lighting to thoroughly illuminate a room. In some cases less luminous flux may be needed with a certain light distribution than another light distribution, enabling more efficient power usage, for example.

Luminaire 100 includes light source 110, structured lightguide 120 including input edge 122, reflector 130, and structured film 140 including prisms 142 and lenslets 144.

Light source 110 may be any suitable light source or combination of light sources. Conventional light sources such as light emitting diodes (LEDs), cold cathode fluorescent lamps (CCFLs), and even incandescent bulbs may be used. In some embodiments, although each light source 110 is depicted as a single object in FIG. 1, combinations of LEDs (for example) may be used to provide a sufficiently white input light, but, depending on the application, any suitable spectrum or combination of spectra may be utilized. Light source 110 may include suitable injection or collimation optics to aid in coupling light into the structured lightguide or to help shape the light input for the structured lightguide. Light source 110 is disposed on either or both sides of the lightguide. Light source 110 on either side may be the same or similar light sources, or they may be different.

Structured lightguide 120 may be any suitable size and shape, and may be formed from any suitable material by any suitable process. For example, structured lightguide 120 may be acrylic or polycarbonate. Structured lightguide 120 may be formed from a process such as injection molding. In some embodiments, structured lightguide 120 may be formed by a two-part process; for example, structured lightguide 120 may be first formed through an injection molding process, and then may have structures formed on it through a cast-and-cure process or similar.

Structured lightguide 120 has at least one of input edge 122. Input edge 122 is typically disposed on the surface of the lightguide closest to light source 110. Input edge may have any suitable shape or structure, including structures to improve coupling of light from the light source into the structured lightguide.

Structured lightguide 120 has a first major surface and a second major surface. The first major surface includes a plurality of prisms and the second major surface includes a plurality of lenslets. These are not detailed in FIG. 1, but are illustrated in FIG. 2. The plurality of prisms may be linear prisms; i.e., the prisms may generally extend in a same direction (for example, in and out of the page), or the prisms may be pyramidal prisms, where the prisms are not significantly extended in a same direction. The prisms may have sharp peaks or the prisms may have rounded peaks. The prisms may have curved facets, flat facets, or both curved and flat facets. The plurality of lenslets may be linear lenslets or lenticulars; i.e, where the lenslets generally extend in a same direction, or the lenslets may be circular or elliptical lenslets, where the lenslets are not significantly extended in a same direction. The plurality of prisms may each have a peak or dihedral angle, and such an angle may be between 90 and 170 degrees, between 120 and 170 degrees, between 140 and 170 degrees, between 150 and 170 degrees, between 160 and 175 degrees, or between 170 and 175 degrees. The lenslets may have any suitable radius of curvature along one or more directions. In embodiments where there is more than one characteristic radius of curvature (i.e., when other radii of curvature are infinite, discontinuous, or otherwise not helpful in describing the shape of the lenslet), the characteristic radii of curvature may be the same, or they may be different. The plurality or prism and the plurality of lenslets may have any suitable pitch (or multiple pitches each in some embodiments), such as between 20 and 100 micrometers. In some embodiments, the pitch of the prisms may be larger or in some embodiments at least twice as large as the pitch of the lenslets. In some embodiments, the pitch of the prisms and the pitch of the lenticulars may be the same or within 5% of one another. If the plurality of prisms extend in a same first direction, and the plurality of lenslets extend in a same second direction, in some embodiments the first direction and the second direction may be parallel, or the first direction and the second direction may be perpendicular. Further, the first direction may be parallel or perpendicular to the propagation direction of light from the light source within the structured light guide.

Reflector 130 may be any suitable reflector such as a metallized or vapor coated mirror. In some embodiments, reflector 130 may be diffuse white PET. In some embodiments, reflector 130 may be a multilayer reflector, such as Enhanced Specular Reflector (ESR) (available from 3M Company, St. Paul, Minn.). Reflector 130 may not be necessary in all embodiments, as light traveling within structured lightguide may be reflected by total internal reflection at the major surfaces because of the interface between higher index material and lower index material (air). Still, reflector 130 may redirect light back toward the output direction of the luminaire and avoid its being wasted or absorbed. Reflector 130 can be a diffuse (Lambertian) reflector, a specular reflector, or a semi-specular reflector with specularity somewhere between diffuse and specular.

Structured film 140 may be any suitable film, any suitable size and shape, and may be formed through any suitable process. Structured film 140 may be injection molded, or it may have its structures formed through a cast-and-cure process or the like. For cast-and-cure processes, a carrier layer may or may not be used. For microreplication processes, any suitable method may be use for forming the tool, including, for example selective etching, photolithography, diamond turning, fly cutting, additive processes, electroplating, or others.

Structured film 140 has a first major surface and a second major surface. The first major surface includes a plurality of prisms 142 and the second major surface includes a plurality of lenslets 144. The plurality of prisms may be linear prisms; i.e., the prisms may generally extend in a same direction (for example, in and out of the page), or the prisms may be pyramidal prisms, where the prisms are not significantly extended in a same direction. The prisms may have sharp peaks or the prisms may have rounded peaks. The prisms may have curved facets, flat facets, or both curved and flat facets. The plurality of lenslets may be linear lenslets; i.e, where the lenslets generally extend in a same direction, or the lenslets may be circular or elliptical lenslets, where the lenslets are not significantly extended in a same direction. The prisms may have land between prisms or they may be continuous. The lenslets may also have land between lenslets or they may be continuous. The plurality of prisms may each have a peak or dihedral angle, and such an angle may be between 60 and 110 degrees, between 60 and 70 degrees, between 70 and 80 degrees, between 80 and 90 degrees, between 90 and 100 degrees, or between 100 and 110 degrees. The lenslets may have any suitable radius of curvature along one or more directions. In embodiments where there is more than one characteristic radius of curvature (i.e., when other radii of curvature are infinite, discontinuous, or otherwise not helpful in describing the shape of the lenslet), the characteristic radii of curvature may be the same, or they may be different. The plurality or prism and the plurality of lenslets may have any suitable pitch (or multiple pitches each in some embodiments), such as between 20 and 100 micrometers. In some embodiments, the pitch of the prisms may be larger or in some embodiments at least twice as large as the pitch of the lenslets. In some embodiments, the pitch of the prisms and the pitch of the lenticulars may be the same or within 5% of one another. If the plurality of prisms extend in a same first direction, and the plurality of lenslets extend in a same second direction, in some embodiments the first direction and the second direction may be parallel, or the first direction and the second direction may be perpendicular. Further, the first direction may be parallel or perpendicular to the propagation direction of light from the light source within the structured light guide.

The configuration of luminaire 100 is such that the second major surface of structured lightguide 120 and second major surface of structured film 140 nearer to one another than the first major surface of structured lightguide 120 and first major surface of structured film 140.

FIG. 2 is a side elevation view of the structured lightguide of the edge-lit luminaire of FIG. 1. Structured lightguide 220 includes prisms 222 and lenslets 224. FIG. 2 illustrates in greater detail a structured lightguide (corresponding to structured lightguide 120 in FIG. 1). As described above, structured lightguide 220 has a first major surface with prisms 222 and a second major surface with lenslets 224. The plurality of prisms may be linear prisms; i.e., the prisms may generally extend in a same direction (for example, in and out of the page), or the prisms may be pyramidal prisms, where the prisms are not significantly extended in a same direction. The prisms may have land between prisms or they may be continuous. The lenslets may also have land between lenslets or they may be continuous. The prisms may have sharp peaks or the prisms may have rounded peaks. The prisms may have curved facets, flat facets, or both curved and flat facets. The plurality of lenslets may be linear lenslets; i.e, where the lenslets generally extend in a same direction, or the lenslets may be circular or elliptical lenslets, where the lenslets are not significantly extended in a same direction. The plurality of prisms may each have a peak or dihedral angle, and such an angle may be between 90 and 170 degrees, between 120 and 170 degrees, between 140 and 170 degrees, between 150 and 170 degrees, between 160 and 175 degrees, or between 170 and 175 degrees. The lenslets may have any suitable radius of curvature along one or more directions. In embodiments where there is more than one characteristic radius of curvature (i.e., when other radii of curvature are infinite, discontinuous, or otherwise not helpful in describing the shape of the lenslet), the characteristic radii of curvature may be the same, or they may be different. The plurality or prism and the plurality of lenslets may have any suitable pitch (or multiple pitches each in some embodiments), such as between 20 and 100 micrometers. In some embodiments, the pitch of the prisms may be larger or in some embodiments at least twice as large as the pitch of the lenslets. In some embodiments, the pitch of the prisms and the pitch of the lenticulars may be the same or within 5% of one another.

Luminaires described herein may provide desirable light distributions. For example, such luminaires may have a viewing angle (i.e., the angular width between the widest angle light) of greater than 100 degrees, greater than 110 degrees, or greater than 120 degrees. Also, such luminaires may have an off-axis primary peak, or a pair of off-axis primary peaks at, for example, between ±45 degrees and ±50 degrees, between ±50 degrees and ±55 degrees, between ±55 degrees and ±60 degrees, between ±60 degrees and ±65 degrees, or between ±65 degrees and ±70 degrees. Combinations of these features may be particularly useful; for example, an angular width of greater than 110 degrees and a pair of off-axis primary peaks between ±55 degrees and ±60 degrees, or an angular width of greater than 120 degrees and a pair of off-axis primary peaks between ±60 degrees and ±65 degrees.

Luminaires described herein may also include any suitable housing for component protection, structural integrity, and to allow such luminaires to be mountable. The housing may be formed from any suitable material and should have at least one exit aperture through which light generated by the light sources passes after exiting the structured film shown in, for example, FIG. 1. The exit aperture may include a diffuser, a transparent plastic film, or other protective layer (such as glass). Such housing may also include or accommodate components for powering or supplying power to the light sources (such as a battery or an electrical cord).

### EXAMPLES

### Example 1

A model of a lighting assembly was prepared and exercised using ASAP optical software (available from Breault Research Organization Inc., Tucson Ariz.). A structured light guide was modeled as a flat slab 300 mm long, 300 mm wide with a 3 mm thickness and a refractive index of 1.49 that was illuminated by LEDs, which were modeled as 1 watt Lambertian sources. A total of 28 LEDs were evenly spaced along two opposing sides of the light guide. The top of the light guide had linear prismatic structures oriented perpendicular to the LED emitting direction. The prisms had an apex angle of 172 degrees and a pitch of 81.6 micrometers. The bottom of the light guide had linear lenticular structures also oriented perpendicular to the LED emitting direction. The lenticular structures had a 35.6 micrometer radius of curvature and a pitch of 45.5 micrometers.

The model also included a structured optical film that was placed on the light guide facing the surface of the light guide with the lenticular features. The film had structures on both sides of a base film of thickness 76.2 micrometers with a refractive index of 1.67. The side of the film facing the light guide had lenticular structures oriented perpendicular to the LED emission direction; the lenticulars had a radius of curvature of 34.5 micrometers, a pitch of 44 micrometers, a height of 7.925 micrometers, and a refractive index of 1.51. The opposite side of the film had prisms also oriented perpendicular to the LED emission direction. The prisms had a 100 degree apex angle, equal base angles of 40 degrees, and an index of refraction of 1.51.

A specular reflector modeled to correspond to 3M Company's ESR film (having 99% reflectance) was placed on the side of the light guide opposite the structured optical film. The entire modeled structure corresponds to that shown in FIG. 1 except that the microstructures on the structured film and the structured lightguide were continuous (i.e., no land between microstructures).

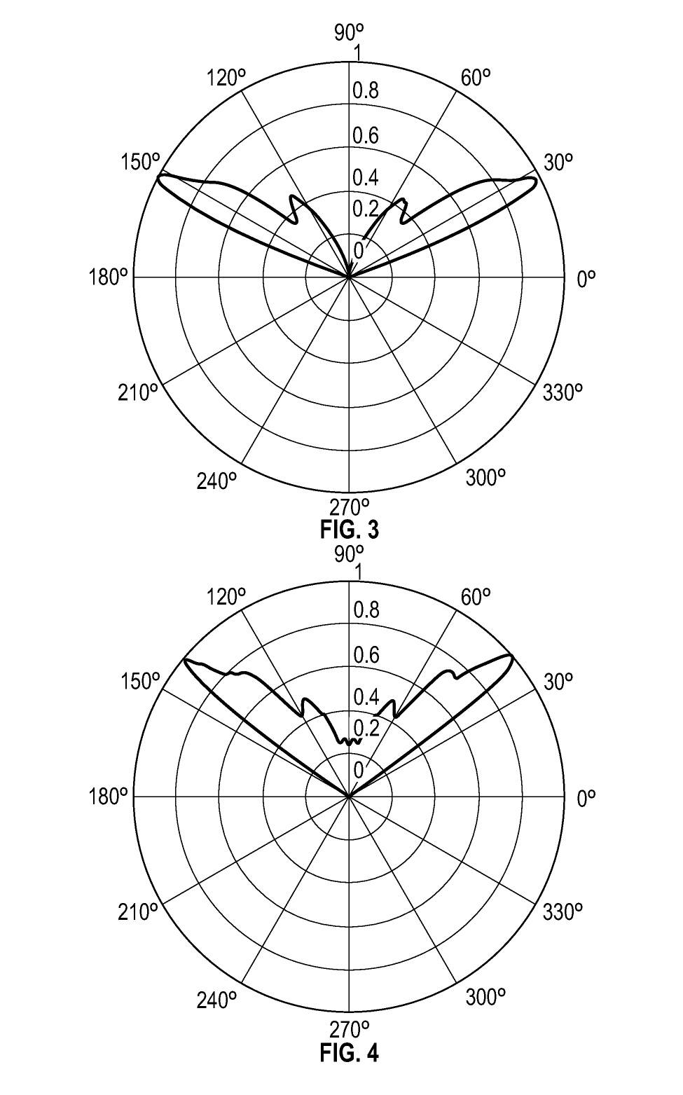

A simulated detector lying immediately below and parallel to the modeled assembly produced the cross-section of the horizontal light distribution shown in FIG. 3.

### Example 2

The assembly of Example 1 was modified to change the prism apex angle and the two base angles to 60 degrees. The model was then exercised to produce the cross-section of the horizontal light distribution shown in FIG. 4.

### Example 3

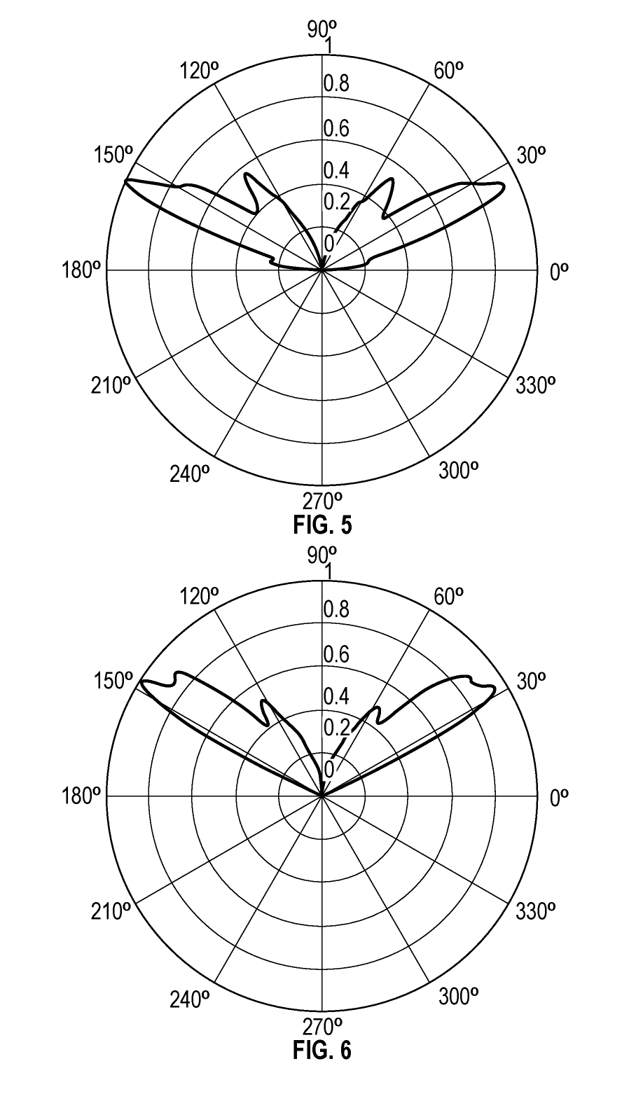

The assembly of Example 1 was modified to change the prism apex angle to 110 degrees and the two base angles to 35 degrees. The model was then exercised to produce the cross-section of the horizontal light distribution shown in FIG. 5.

### Example 4

The assembly of Example 1 was modified to change the prism apex angle to 86 degrees and the two base angles to 47 degrees. The model was then exercised to produce the cross-section of the horizontal light distribution shown in FIG. 6.

### Comparative Example 1

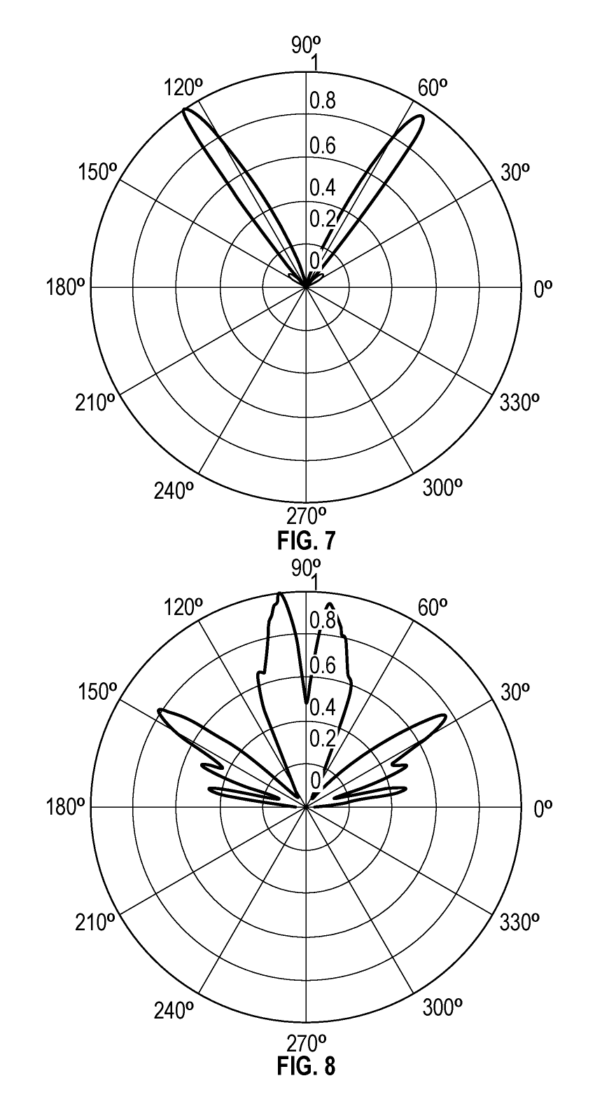

The assembly of Example 4 was modified to remove the lenticular structures from the structured optical film. The model was then exercised to produce the cross-section of the horizontal light distribution shown in FIG. 7.

### Comparative Example 2

The assembly of Example 4 was modified to replace the lenticular structures on the structured optical film with the same prisms structures used on the opposite side of the film. The model was then exercised to produce the cross-section of the horizontal light distribution shown in FIG. 8.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

What is claimed is:

1. An edge-lit luminaire comprising:
a light source;
a structured lightguide having an input edge, a first major surface including a plurality of prisms, and a second major surface including a plurality of lenslets;
a structured film having a first major surface including a plurality of prisms and a second major surface including a plurality of lenslets;
wherein the luminaire is configured such that the second major surface of the structured lightguide and the second major surface of the structured film are nearer one another than the first major surface of the structured lightguide and the first major surface of the structured film.

2. The edge-lit luminaire of claim 1, further comprising a reflector disposed proximate the first major surface of the structured lightguide.

3. The edge-lit luminaire of claim 1, further comprising a second light source.

4. The edge-lit luminaire of claim 1, wherein the plurality of prisms of the structured lightguide have peak angles between 150 and 170 degrees.

5. The edge-lit luminaire of claim 1, wherein the plurality of prisms of the structured lightguide have peak angles between 170 and 175 degrees.

6. The edge-lit luminaire of claim 1, wherein the structured film includes a first film having the plurality of prisms of the first major surface and a second film having the plurality of lenslets of the second major surface.

7. The edge-lit luminaire of claim 1, wherein the structured film is a monolithic film.

8. The edge-lit luminaire of claim 1, wherein the plurality of prisms of the structured film have peak angles between 80 and 90 degrees.

9. The edge-lit luminaire of claim 1, wherein the plurality of prisms of the structured film extends in a first direction perpendicular to a propagation direction of light from the light source within the lightguide, and the plurality of lenslets extends in the same first direction.

10. The edge-lit luminaire of claim 1, wherein the plurality of prisms of the structured film extends in a first direction perpendicular to a propagation direction of light from the light source within the structured lightguide, and the plurality of lenslets extends in a second direction perpendicular to the first direction and parallel to the propagation direction of light from the light source within the structured lightguide.
